(19) United States
(12) Patent Application Publication
(10) Pub. No.: US 2025/0391193 A1
(43) Pub. Date: Dec. 25, 2025

(54) SYSTEM AND METHODS FOR MANAGING UPLOADED DOCUMENT

(71) Applicant: Kyocera Document Solutions Inc., Osaka (JP)

(72) Inventors: Selim ZAMAN, San Mateo, CA (US); Chikara YUKI, Walnut Creek, CA (US)

(73) Assignee: Kyocera Document Solutions Inc., Osaka (JP)

(21) Appl. No.: 18/751,897

(22) Filed: Jun. 24, 2024

(51) Int. Cl. G06V 30/19; G06F 40/103; G06F 40/40; G06V 30/30; G06V 30/41; G06V 30/42

(52) U.S. Cl. CPC G06V 30/1916; G06F 40/40; G06V 30/30; G06V 30/41; G06V 30/42; G06F 40/103

(57) ABSTRACT

A document management system and method are disclosed. A bulk of electronic documents are uploaded to the document management system. An OCR language setting module is provided within the document management system. The OCR language setting module performs a first OCR operation on a first document of the bulk of electronic documents using a first language, and compares an accuracy level of the OCR performance with a preset threshold level. If the accuracy meets the preset threshold level, the first language will be set as the OCR language settings. This OCR language settings will be used to perform OCR operations on all remaining documents of the bulk of electronic documents. If the accuracy level of the first OCR operation does not meet the threshold level, the system runs a second OCR operation on the first document using a second language.

### FIELD OF THE INVENTION

The present invention relates to a system and method for managing uploaded documents. In particular, the present invention relates to an OCR performance optimization system for bulk imported multilingual documents with similar linguistic content.

### DESCRIPTION OF RELATED ART

Optical Character Recognition (OCR) is a technology that converts printed text into digital format. It's like a digital copy machine that automates the transformation of scanned documents into machine-readable PDFs. When uploading documents contain multiple languages, OCR can be used to converts texts in different languages into digital formats. However, when OCR is performed on multiple documents uploaded in bulk, users will notice the slowness of the processing speed is slow and a low accuracy of the conversion and become frustrated.

Therefore, the present invention aims at improving the efficiency and accuracy of the OCR performance on documents, in particular, on documents loaded in bulk. Currently, there are no document managing system and method can solve this problem without requiring manual intervention.

### SUMMARY OF THE INVENTION

A computer-implemented method for improving OCR performance of documents is disclosed. The method detects languages contained in a first document among a plurality of uploaded documents, runs a first OCR performance using a first language on the first document, and obtains an OCR accuracy level of the first document after the first OCR performance. If the obtained OCR accuracy level meets a preset threshold level, the method sets the first language as an OCR language setting; while if the obtained OCR accuracy level does not meet the preset threshold level, the method will run a second OCR performance using a second language on the first document. When the OCR language setting is determined, the determined OCR language setting will be used in OCR performances on any of remaining documents of the plurality of documents.

The first document is a sample document. The method merely needs to determine the OCR language setting from the first document. There is no need to perform same procedures on any of the remaining documents. The determined OCR language setting is used for any of other document in the plurality of uploaded documents.

The above computer-implemented method further comprises adjusting language settings based on the obtained OCR accuracy level if the obtained accuracy level does not meet the preset threshold level, and re-run the OCR performance on the first document using adjusted language settings until an obtained accuracy level meets the preset threshold level.

Further, if an accuracy level obtained after running the OCR performance on the first document for a predetermined time still fails to meet the preset threshold, the computer-implemented method further comprises sending an alert message to a user for manual intervention.

The adjusting the language setting may include includes reducing the threshold level, and re-running the OCR using the first and second languages on the first document.

Another computer-implemented method for improving OCR (optical character recognition) performance of bulk documents is also disclosed. The method includes uploading a plurality of multi-lingual documents, detecting languages contained in the plurality of multi-lingual documents, detecting categories of the plurality of multi-lingual documents, wherein the categories are set based on the languages contained therein, running a first OCR performance on a sample document using a first language, obtaining an accuracy level of the first OCR performance, comparing the obtained accuracy level with a preset threshold level, setting the first language as an OCR language setting if the obtained accuracy level meets a preset threshold level in a database, running a second OCR performance on the sample document using a second language if the obtained accuracy level does not meet the preset threshold, and after the OCR language setting is determined, running an OCR performance on all remaining documents within a same category of the sample document using the OCR language setting.

The step of running the OCR performance is repeated if the accuracy level does not meet the threshold level. Also, if the OCR performance is re-run for a predetermined number of times and an accuracy level obtained then still fails to meet the threshold level, the method will send sending an error message to a user so that the user can manually adjust the language settings or reducing the threshold level before re-running the OCR performance.

A system for managing OCR (optical character recognition) performance of documents is further disclosed. The system includes a database storing a plurality of multi-lingual documents, and a managing device accessible to the plurality of documents stored in the database. The managing device includes a processor, wherein the database further stores medium-readable instructions, which when executed, causes the processor to detect languages contained in the plurality of multi-lingual documents stored in database, run a first OCR performance using a first language on a sample document, obtain an accuracy level of the first OCR performance, setting the first language as an OCR language setting if the obtained accuracy level meets a preset threshold level in a database, run a second OCR performance using a second language on the sample document fit the obtained accuracy level does not meet the preset threshold level, and when the OCR language setting is determined, run an OCR performance on any one of remaining document of the plurality of documents using the determined OCR language setting.

### BRIEF DESCRIPTION OF THE DRAWINGS

Various other features and attendant advantages of the present invention will be more fully appreciated when considered in conjunction with the accompanying drawings.

FIG. 1 depicts a block diagram of a document management system according to the disclosed embodiments.

FIG. 2 illustrates an OCR device according to the disclosed embodiments.

FIG. 3 depicts a block diagram of OCR language setting module in accordance with the disclosed embodiments.

FIG. 4 illustrates a flow chart of a process for obtaining OCR language settings in accordance with the disclosed embodiments.

FIG. 5 depicts a block diagram of document management module in accordance with the disclosed embodiments.

FIG. 6 illustrates a flow chart of a process for operating OCR on a multiple-language document in accordance with the disclosed embodiments.

FIG. 7 depicts a flow chart 0 of a method for efficiently managing a bulk of uploaded documents in accordance with the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a novel OCR (Optical Character Recognition) module within a document management system to process uploaded multilingual documents with similar linguistic contents. The disclosed embodiments further provide an OCR accuracy measurement module within the document management system for OCR language settings. The OCR language settings are determined from a sample document, usually a first electronic document of a plurality of uploaded documents. After performing the OCR on the sample document with initial OCR language settings, the accuracy measurement module determines if an accuracy rate reaches or is above a threshold value. If the accuracy rate reaches the threshold value, the system will preset this initial OCR language settings as OCR language settings. The OCR language settings will be stored in a cache and are in turn used on the OCR performance for remaining electronic documents so that the processing time of the remaining electronic documents and their accuracies can be improved.

The disclosed embodiments are preferably suited for performing the OCR on multi-language documents. If a document contains multiple languages in distinct sections, i.e., a language section only contains one single language, and the language sections can be separated within the document in a clean manner, then the document is split into multiple files based on the language sections. Each of the distinct sections may has a pre-determined number of pages or a predetermined number of lines of a document content. The multiple files are then processed with an OCR device with a single language setting for the respective files containing that language. In some cases, there will be more than one set of sectioned files, such as one set of first language sectioned files, one set of second language sectioned files, and so on. Each set of language sectioned files will be processed, respectively, by the OCR device with a language setting contained only in the set of language sectioned files. After all language sectioned files of the document have run through the OCR device, the sectioned files are merged back together to restore the original document in a searchable PDF format.

The disclosed embodiments aim to increase the efficiency and accuracy of performing the OCR on documents uploaded in bulk, in particular on multi-language or multi-lingual documents. When dividing a multi-language original document into a plurality of sectioned files based, each of the sectional files will be embedded with an identifier, an index or metadata, indicating the its original location on the original document. After all the plurality of sectional files have been run though the OCR performance, they can be merged back together based on the embedded identifiers to restore the original document. The identifier, index or metadata can be stored in a memory cache until the bulk documents are processed completely or is reset by a user.

Document management system 100 may receive a bulk of documents including a first electronic document 102 and a second electronic document or remaining electronic documents 104, processing them, and manage their access and use in operations. As part of this, document management system 100 includes OCR language setting module 120 and document management module 140. OCR language setting module 120 runs an OCR performance on a first electronic document 102 (also called a sample document) to obtain

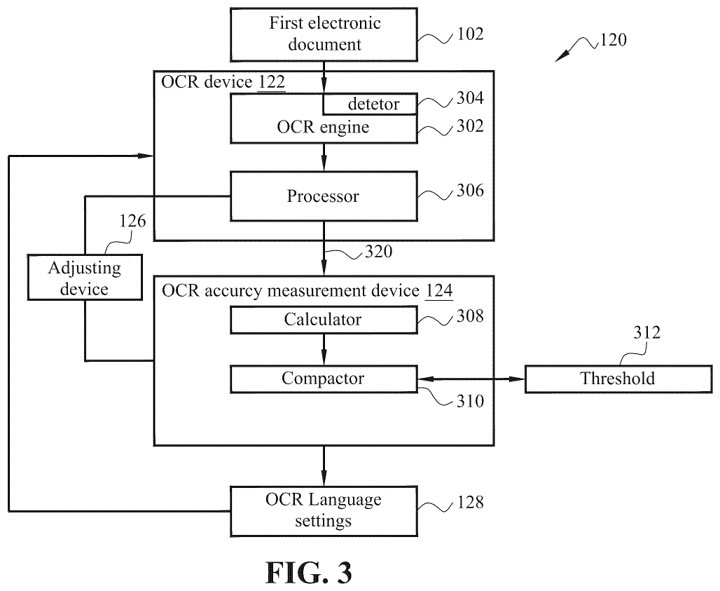

OCR language settings 128, which can be used on a second electronic document 104 or remaining electronic documents. Document management module 140 deals with all of the uploaded documents and run the OCR performance based on certain conditions. Details of OCR language setting module 120 and document management module 140 will be described in FIGS. 3-8. It is noted that modules 120 and 140 can exist independently as either one of modules 120 and 140 is unique and novel by itself.

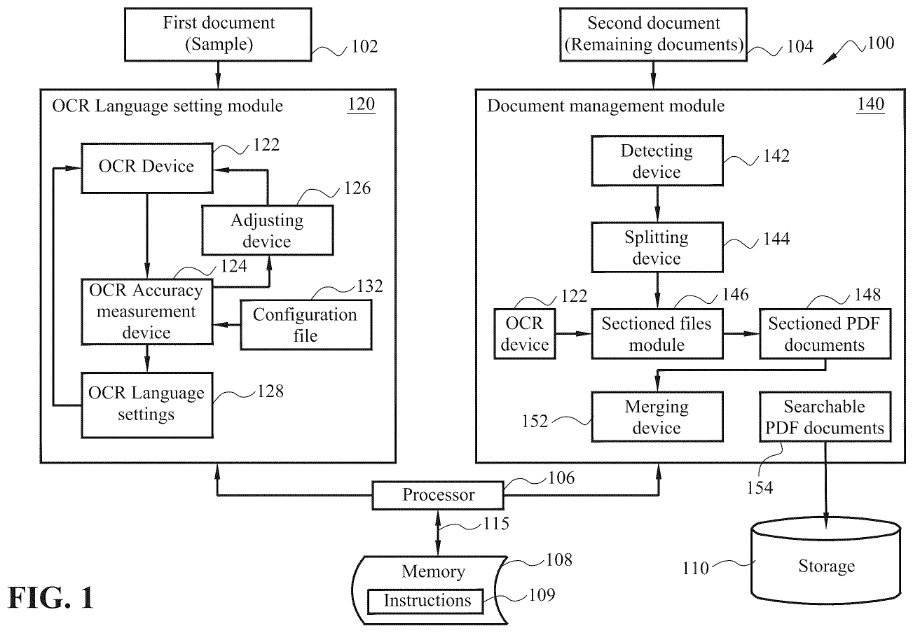

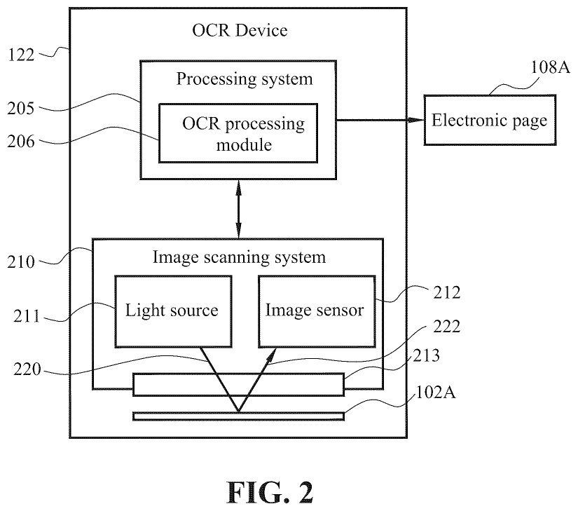

OCR language setting module includes an OCR device 122, an OCR accuracy measurement device 124, and an adjusting device 126. OCR device 122 is communicatively coupled to processor 106 within system 100. OCR device 122 may be connected to system 100 over a network or an internet (not shown). OCR device 122 may be within a printing device, a scanner, a computing device, and the like. OCR device 122 is disclosed in greater detail below by FIG. 2. In FIG. 1, although OCR device 122 is shown within OCR language setting module 120, OCR device 122 may also be a part of document management module 140. Within system 100, OCR device 122 helps with the importation of large batches of documents, such as records, books/texts, forms, or other data that is in a document that is captured electronically to be managed using system 100.

System 100 receives large batches of uploaded documents. The uploaded documents may be imported from an old document system or from a database of a new registered company. Some of the uploaded documents may contain multiple languages. Therefore, in accordance with the disclosed embodiments, the uploaded documents are preferably processed based on their characteristics. For example, documents with similar lingual formats will be processed together. For example, a first electronic documents 102 and a second electronic document 104 (or remaining electronic documents) may contain a same language or same multiple languages. Normally, if the first electronic document 102 and the second electronic document 104 contains only one language, OCR device 122 captures images of first electronic document 102 and second electronic document 104 to generate searchable PDF documents thereof. However, when there are multiple languages in each of the first and the second (remaining) documents 102 and 104, processing a bulk of such documents will take a lot of time as it will require OCR device 122 to perform the OCR sequentially with each language contained therein.

To reduce the processing time, documents 102 and 104 may be pre-processed with processor 106 to determine if there are distinct sections in which one language is appeared.

A distinct section means that a predetermined number of lines or paragraphs or pages of the document contents contains only one language or mostly one majored language, which is distinguishable and dividable by processor 106. If there are distinct sections, document 102 or 104 are divided into a number of sectioned files. The number of sectioned files are then processed by OCR device 122 respectively with its respective language setting. However, if document 102 or 104 does not have separable distinct sections or has un-separated sections, OCR language setting module 120 will run an OCR performance on the entire document or the un-separated sections through OCR device 122 to determine suitable OCR language settings.

In accordance with the disclosed embodiments, OCR language setting module 120 performs only first electronic document 102 among a group of uploaded documents with a similar lingual format. As the group of uploaded documents has similar lingual format, OCR language settings obtained from processing first electronic document 102 (or a sample document) will be suitable for use in OCR performing on second electronic document or remaining electronic documents 104 of the group of uploaded documents.

OCR device 122 has built-in functions on detecting languages contained in first electronic document 102. OCR device 122 may select a number of languages (for example, three prominent languages) as initial OCR language settings and run an OCR performance on first electronic document 102 with the initial OCR language settings.

OCR accuracy measurement device 104 determines if an accuracy after a first OCR performance meets a threshold value, which is pre-set by a user and saved in configuration file 132. Adjusting device 126 adjusts the initial OCR language settings if the accuracy fails to meet the threshold and re-run the OCR performance on first electronic document 102 using the adjusted OCR language settings until the accuracy meets the threshold value. At this time, a final OCR language settings will be preset as OCR language settings 128 that will be used on OCR performing of second electronic document or remaining document 104.

Document management module 140 includes a detecting device 142, a splitting device 144, a sectioned files module 146, and a merging device 152.

Detecting device 142 detects any one of first electronic document 102 and second electronic document or remaining electronic documents 104 (collectively “second electronic document 104” hereinafter) to determine if there are distinct sections in first electronic document 102 or second electronic document 104 that contain only one or majorly one single language. As first electronic document 102 or second electronic document 104 may contain multiple languages, there may be multiple groups of distinct sections, each of which contain one different language.

If the distinct sections are separable, splitting device 144 divides them into a plurality of sectioned files based on the number of the distinct sections. Further, splitting device 144 embeds each of the plurality of sectioned files with an identifier (not shown in FIG. 1). The identifier may be an index or a metadata or a header that indicates an original location of each of the plurality of sectioned files.

Section files module 146 receives the plurality of sectioned files and performs OCR through OCR device 122 on them with their respective language settings to generate a plurality of sectioned PDF documents 148.

Merging device 152 merges the plurality of sectioned PDF document 148 together based on the identifiers embedded therein to restore the original first electronic document in a searchable PDF form 154.

The searchable fist PDF document is then saved in storage 110.

Processor 106 interacts with OCR language setting module 120 and document management module 140 to pre-process first electronic document 102 and second electronic document 104 and remaining electronic documents. This pre-processing may includes obtaining OCR language settings 128 and detecting and splitting documents 102 and 104 into the plurality of sectioned files. Processor 106 further interacts OCR language setting module 120 and document management module 140 to post-process first electronic documents 102, second electronic document 104 and the remaining electronic documents. The post-process may perform OCR on the plurality of sectioned files to obtain the plurality of sectioned PDF documents 148 and merges the plurality of sectioned PDF documents 148 into its original document with a searchable PDF document 154.

Processor 104 is connected to memory storage 108 by data bus 115. Memory storage 108 includes instructions 109. Instructions 109 may be code that, when read by processor 114, configures system 100 or OCR language setting module 120 and document management module 140 to perform the operations disclosed herein.

Processor 106 also may be coupled to OCR device 122. Electronic document 102 and 104 and the remaining document may be imported from OCR device 122. In some embodiments, system 100 and OCR device 106 may be in the same device such that a network and input/output interface (not shown) are not used. Upon receipt of the electronic documents, processor 106 executes instructions 109 to configure system 100 to perform the pre-processing and post-processing operations.

FIG. 2 depicts OCR device 122 according to the disclosed embodiments. OCR device 122 receives a page or document 102A of first electronic document 102. Further pages may be loaded after processing of page 102A is complete. OCR device 122 includes an image scanning system 210 communicatively coupled to a processing system 205 via a communications link 207. Communications link 207 may be a wire, a communications cable, a wireless link, or a metal track on a printed circuit board.

Image scanning system 210 includes a light source 211 that projects light 220 through a transparent window 213 to strike a surface of page 102A. Page 102A, which may be a sheet of paper containing text or graphics, reflects light 220 towards an image sensor 212. Image sensor 212 contains light sensing elements, such as photodiodes or photocells, converts received light 222 into electrical signals that are transmitted to OCR processing module 206 within processing system 205. The electrical signals may be digital bits.

Processing system 205 generates electronic page 108A from the captured data for page 102A. Electronic page 108A is included in one of the electronic documents within first electronic document 102. In some embodiments, OCR device 122 is a slot scanner incorporating a linear array of photocells. OCR processing module 206 that is a part of processing system 205 may be used to operate upon the electrical signals for performing optical character recognition of text and graphics printed on page 102A.

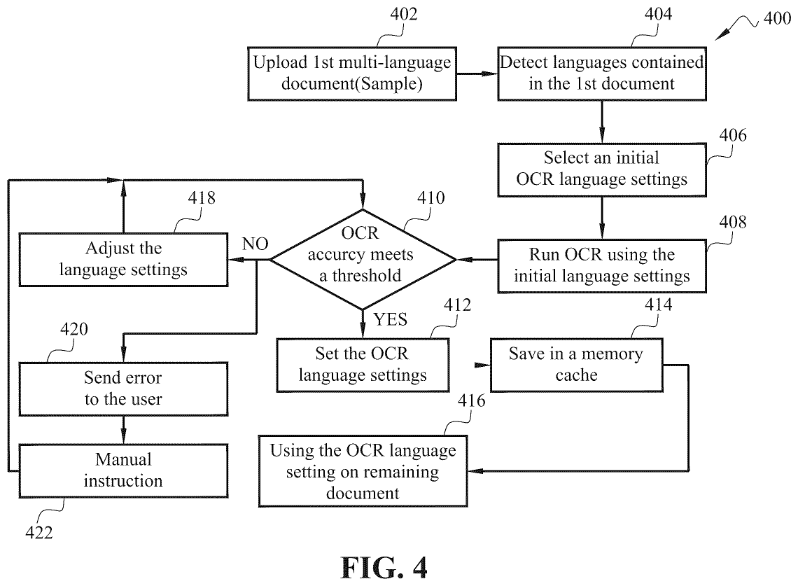

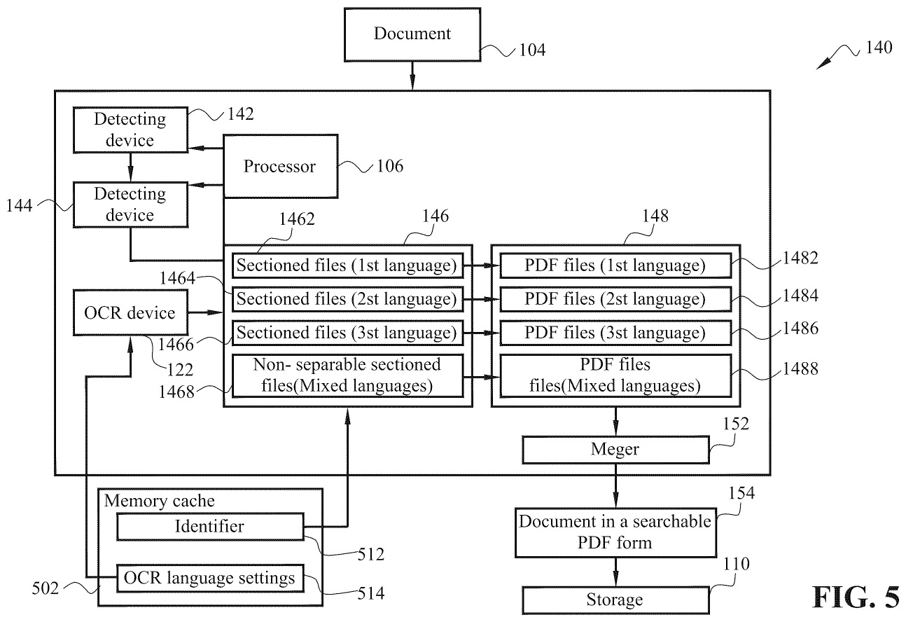

In some embodiments, OCR language setting module 120 and document managing module 140 of the disclosed embodiments may operate independently or cooperatively. Therefore, in the following descriptions, FIGS. 3-4 will illustrate a block diagram of OCR language setting module 120 and a process 400 for obtaining preset OCR language settings by using the OCR language setting module 120. FIGS. 5-7 will discuss a block diagram of document management module 140 and processes 600 and 700 for performing the OCR on the bulk of uploaded electronic documents using the document management module 140. FIG. 8 will discuss how OCR language setting module 120 and document management module 140 cooperate to achieve an OCR performance optimization system 800 for bulk imported multilingual documents with similar linguistic content.

FIG. 3 depicts a block diagram of OCR language setting module 120 in accordance with the disclosed embodiments. For the purpose of simplification, same elements that have been disclosed in FIG. 1 will be marked with same reference numbers. In FIG. 3, only first electronic document 102 is shown as OCR language setting module 120 only process a first electronic document among a group of electronic documents with a similar language format.

First electronic document (or sample electronic document) 102 contains multiple languages in its content. OCR device 122 shown in FIG. 3 is a simplified version of FIG. 2 to illustrate elements included but not shown in processing system 205 of FIG. 3.

OCR device 122 includes an OCR engine 302, a detector 304 and a processor 306. Detector 302 detects the languages contained in first electronic document 102. Processor 306 selects a number of languages from the detected languages as initial OCR language settings. OCR engine 302 performs the OCR on first electronic document 102 using the initial OCR language settings. Processor 306 outputs a result 320 of the operation to OCR accuracy measurement device 124.

OCR accuracy measurement device 124 includes a calculator 308 for calculating an OCR accuracy from the received result 320. Comparator 310 then compare the calculated OCR accuracy with a threshold 312 that is stored in configuration file 132 of FIG. 1.

Adjusting device 126 can adjust the initial OCR language settings if the calculated OCR accuracy fails to meet threshold 312 to generate new OCR language settings. The new OCR language settings are then used to perform the OCR on first electronic document 102 again. A new result is then sent to OCR accuracy measurement device 124 to evaluate if a new OCR accuracy calculated from the new result meets threshold 312. The same process continues until suitable OCR language settings 128 is obtained.

FIG. 4 illustrates a flow chart 400 of a process for obtaining OCR language settings 128 in accordance with the disclosed embodiments. Flow chart 400 depicts a method for obtaining OCR language settings 128 in more details.

Step 402 executes by uploading first multi-language electronic document or sample electronic document 102.

Step 404 executes by detecting multiple languages contained in the first electronic document 102. This step may be executed by processor 106 or processor 306 of OCR device 122.

Step 406 executes by selecting a number of languages that seem most prominent as initial OCR language settings. For a best efficient result, the number of languages that can be selected has a limit, for example, at most three languages. If more than three languages are selected as initial OCR language settings, it would take a longer time to perform the OCR on documents. Here, the “three”-language limitation is for an exemplary purpose only. Other number of selectable languages may be various, depending on the speed and efficiency of different OCR devices.

Step 408 executes by running the OCR on first electronic document 102 using the initial OCR language settings.

Step 410 then executes by comparing the calculated OCR accuracy with the threshold. An OCR accuracy of the OCR performance will be calculated and compared with a threshold. The threshold is pre-set by a user, which can be in percentage terms, such as 90%, 95%, or 99% of accuracy. In some embodiments, an additional threshold for duration (for example, per page) can be used as well as the accuracy threshold. In this case, the OCR engine will go through one language at a time until both the accuracy and the duration thresholds have been reached.

When the OCR accuracy meets the threshold at step 410, step 412 executes by using the initial OCR language settings as preset OCR language settings. The present OCR language settings are then saved in a memory cache at step 414.

Next, step 416 executes by using the preset OCR language settings on other remaining documents with the similar lingual format of the first electronic document 102.

When the OCR accuracy fails to meet the threshold at step 410, step 418 executes by adjusting the initial OCR language settings. The adjustment of OCR language settings may include replacing one or more languages with one or more different languages or changing a ratio of the language settings, or the like, and is not limited to the ones mentioned. New OCR language settings are then used to perform the OCR on first electronic document 102. A new OCR accuracy is then obtained, and is compared with the threshold at step 410. Steps 410-418 will be repeated for a predetermined of time until suitable OCR language settings 128 is obtained.

In some embodiments, steps 410-418 may be repeated many times but the OCR accuracy still fails to meet the threshold. Therefore, if after a specified number of attempts and the OCR accuracy is still not achieved, process 400 will be paused with an error message provided to the user.

Step 420 executed by pausing the process 400 and sending an error message to the user. The error message may be in a form of a text message or a pop-up window message on the user's computing device.

Next, step 422 executes by the user manually intervening the attempted OCR language settings to adjust the language settings or reduce the accuracy threshold before performing the OCR on the first electronic document again. Steps 420, 422, and 410-416 will be repeated until last OCR language settings meets the threshold. This last OCR language settings will be the preset OCR language settings, and will be used to perform the OCR on other documents.

FIG. 5 depicts a block diagram of document management module 140 in accordance with the disclosed embodiments. As an example, a document, such as second document 104 is uploaded and processed by document management module 140. For the purpose of simplification, same elements that have been disclosed in FIG. 1 will be marked with same reference numbers.

Document management module 140 includes detecting device 142 and a splitting device 144 that couples with processor 106 to perform operations. Detecting device 142 detects languages contained in multiple-language electronic document 104 and determines if there are distinct sections in document 104 that can be separated in a clean manner. As described above, a distinct section means that in a certain lines or paragraphs, or in certain number of pages of document content, only one single language or majorly one single language is present. The number of lines, paragraphs and pages are predetermined by a user. There may be a plurality of distinct section groups, each of which containing a language different from other group(s). For example, a first group of distinct sections contain only or majorly a first language, a second group of distinct sections contain only or majorly a second language, and a third group of distinct sections contain only or majorly a third language. In addition to the distinct section groups, document 114 may further include non-separable sections containing more than one language.

Splitting device 144 divides document 114 into sectioned files based on the detected distinct sections. If document 104 further include non-separable sections that contain more than one language, splitting device 144 further divided such non-separable sections into non-separable sectioned files. In the exemplary embodiment of FIG. 5, document 114 is divided into first language sectioned files 1462, second language sectioned files 1464, third language sectioned files 1466, and non-separated sectioned files (mixed languages.) During the dividing process, splitting device 144 further embeds identifiers 512 that are saved in a memory cache 502 within system 100 (not shown in FIG. 1) to the sectioned files 1462, 1464, 1466, and 1468. Identifiers 512 may be in a form of an index, metadata or header, for indicating the original locations of the sectioned files.

Sectioned file module 146 operates sectioned files 1462, 1464, 1466, and 1468 by performing OCR on them. As sectioned files 1462-1466 each contain a single language, OCR device 122 will perform first language sectioned files 1462 using the first language settings, second language sectioned files 1464 using the second language settings, and third language sectioned files 1466 using the third language settings. As to the mixed language non-separable sectioned files 1468, OCR device 122 will perform these sectioned files using the preset OCR language settings 514 obtained by process 400 of FIG. 4. As described, the preset OCR language settings 514 are also saved in memory cache 502.

After the OCR operations, the sectioned files 1462-1468 will be transformed into first language PDF documents 1482, second language PDF documents 148, third language PDF document 1486, and mixed language PDF documents 1488.

Merger 152 is used to merge all of PDF documents 1482-1488 back together based on identifiers 514 embedded therein. Therefore, document 104 will be restored to a document 154 in a searchable PDF form. The restored document 154 is then saved in storage 110 for later use.

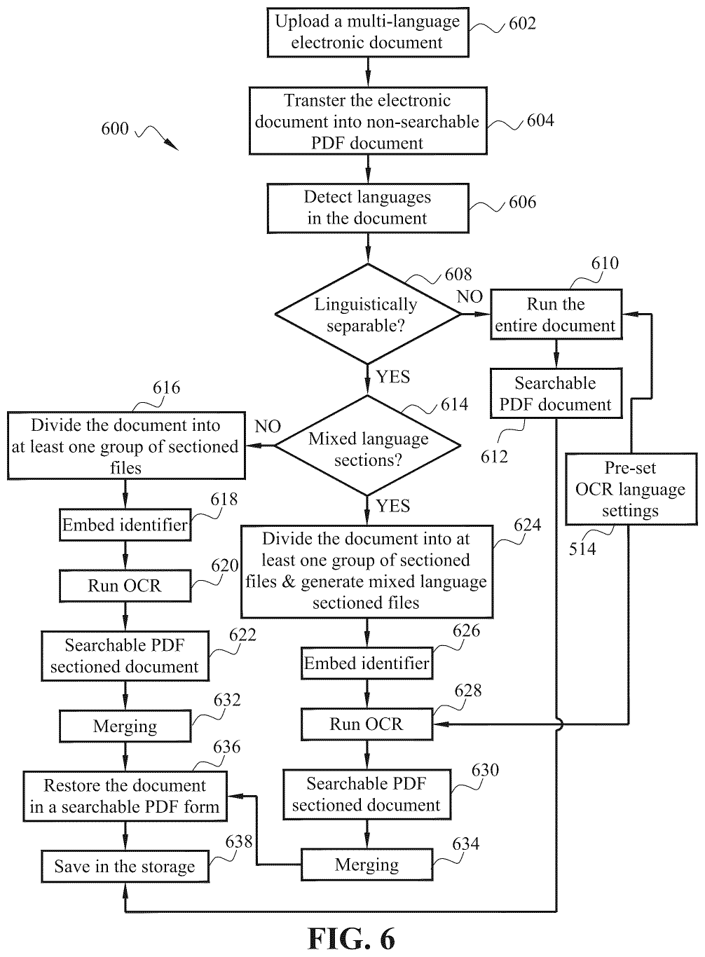

FIG. 6 illustrates a flow chart 600 of a process for operating OCR on a multiple-language document in accordance with the disclosed embodiments. The multiple-language electronic document in FIG. 6 may be first document 102 or second document 104.

Step 602 executes by uploading a multi-language electronic document, such as second document 104.

Step 604 executed by transforming the electronic document into a non-searchable PDF document.

Step 606 executes by detecting languages contained in the non-searchable PDF document.

Step 608 executes by determining if there are linguistically distinct sections in the non-searchable PDF document that can be separated in a clean manner. According to the disclosed embodiments, the non-searchable PDF document may include multiple distinct section groups, each of which containing a language different from other group(s). That is, one group of distinct sections contain only or majorly a first language, one group of distinct sections contain only or majorly a second language, and so on.

If there are no linguistically distinct sections existed in the non-searchable PDF document at step 608, step 610 executes by running an OCR on the entire non-searchable PDF document using preset OCR language settings 514 saved in memory cache 502 of FIG. 5. A searchable PDF document 612 of the non-searchable PDF document is then generated after step 610. The searchable document 612 is in turn saved in storage 110, as shown in step 636.

At step 608, if there are linguistically distinct sections existed in the non-searchable PDF document, step 614 executes by determining if there are mixed language sections in the non-searchable document.

If the answer of step 614 is No, step 616 executes by dividing the non-searchable PDF documents into at least one group of sectioned files. As mentioned, the number of the group of sectioned files are based on how many language groups of distinct sections exists.

Step 618 executes by embedding identifiers in each of the sectioned files to indicate their respective original locations in the non-searchable PDF document. The identifiers are saved in memory cache 502, which are like demarcation makers to flag how to recombine the sectioned files back into their original document, that is, the non-searchable PDF document.

After step 618, step 620 executes by running an OCR performance on the at least one group of sectioned files generated at step 616 using a respective language setting contained in the at least one group of sectioned files. That is, if a first group of sectioned files contains a first language, the OCR performance uses the first language setting on the first group of sectioned files. If a second group of sectioned files contains a second language, then the OCR performance uses the second language setting on the second group of sectioned files. Those sectioned files may be collectively called as single-language sectioned files.

The OCR performance further transfers the sectioned files into searchable PDF sectioned documents. Therefore, at step 622, searchable PDF sectioned documents for the sectioned files are generated.

Next, step 632 executes by combining all searchable PDF sectioned documents generated at step 622 based on the embedded identifiers, and step 636 executes by restoring the uploaded document in a searchable PDF form.

Back to step 614. If the answer to step 614 is Yes, step 624 executes by dividing the documents into at least one group of sectioned files as in step 616, and generating mixed-language sectioned files.

Step 626 executes by embedding identifiers to each of the sectioned files generated at step 614.

Next, step 628 executes by running an OCR performance on the mixed-language sectioned files using preset OCR language settings 514, and on the at least one group of sectioned files, as in step 620.

After the OCR performance of step 628, step 630 executes by generating searchable PDF sectioned documents corresponding to the single-language sectioned files and mixed-language sectioned files.

Next, step 634 executes by merging the searchable PDF sectioned documents generated at step 628 by combining the searchable PDF sectioned documents based on their embedded identifiers. Therefore, step 636 executes by restoring the original uploaded documents in a searchable PDF form.

The restored document in a searchable PDF form is then saved in storage 110, as shown at step 638.

In accordance with the disclosed embodiments, OCR language setting modules 120 and document managing module 140 may be operated independently, as explained in FIGS. 3-4 and FIGS. 5-6. OCR language setting module 120 and document managing module 140 may also operate together, as shown and explained in FIG. 1. The combination of modules 120 and 140 may further improve the efficiency and speed of managing a bulk of uploaded documents.

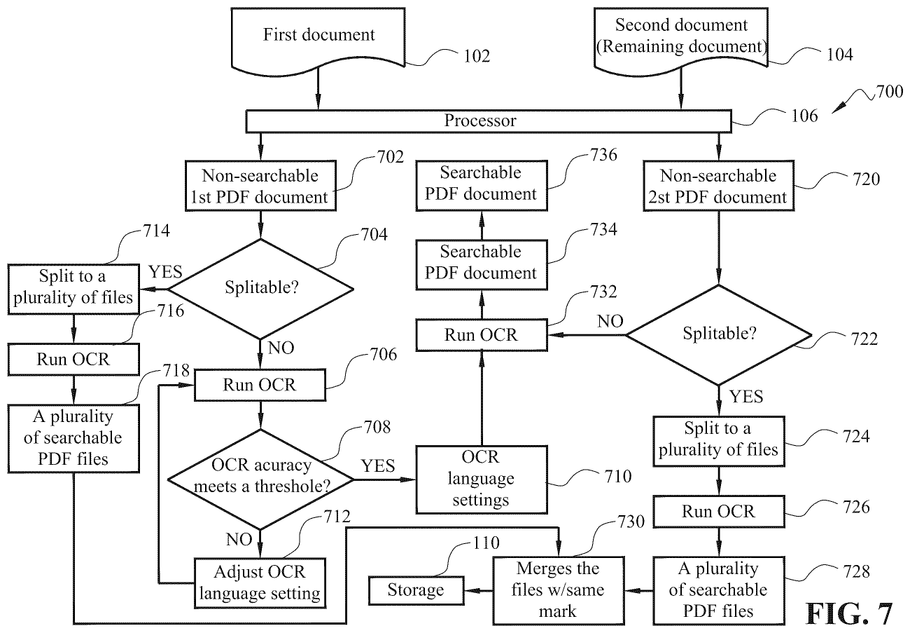

FIG. 7 depicts a flow chart 700 of a method for efficiently managing a bulk of uploaded documents in accordance with the disclosed embodiments. In FIG. 7, elements that have shown in the previous figures will be marked as the same numbers in the previous figures. Also, some steps in FIG. 7 that have been explained in FIGS. 3-6 will be describes briefly to omit redundant statements.

In FIG. 7, first electronic document (i.e., sample document) 102 and second electronic document 104 (or remaining documents) are uploaded to system 100 of FIG. 1 and are coupled to processor 106. Steps 702 and 720 execute by processing 106 converting first electronic document 102 and second electronic document 104 into non-searchable first PDF document and non-searchable second PDF document.

Steps 704 and 722 executes by determining if the non-searchable first PDF document and the non-searchable second PDF document contain distinct sections, each of which contains only one or majorly one single languages.

If the answer to steps 704 and 722 are Yes, steps 714 and 724 divide the non-searchable first PDF document and the non-searchable second PDF document into a plurality of sectioned files.

Next, steps 716 and 726 executes by performing OCR on the plurality of sectioned files generated at steps 714 and 724, and steps 718 and 728 executes by generating a plurality of searchable sectioned PDF documents.

Step 730 executes by merging all the plurality of sectioned PDF documents to restore the first document 102 and the second document 104 in searchable PDF forms. Step 110 executes by storing the restored first document 102 and the restored second document 104 in storage 110.

The above-mentioned steps 702, 720, 704, 722, 714, 724, 716, 726, 718, 728, and 730 are similar to steps 616-632, and 636-638. Therefore, no redundant descriptions are needed for these steps.

Further, although steps 624-630 are not shown in FIGS. 7, it is understandable that these steps can also incorporated into flow chart 700 of FIG. 7 when there are mixed-language sections appeared in either or both of first document 102 and second document 104.

Continue to steps 704 and 722 of FIG. 7. If the answer to steps 704 and 722 are No, which means there are no distinct sections detected in the non-searchable first PDF document and the non-searchable second PDF document. Then, for the first non-searchable PDF document (also the sample document), step 706 executes by performing an OCR on the entire non-searchable first PDF document with initial language settings. Selecting the initial language settings have been explained in FIGS. 3 and 4. Therefore, further explanation of the initial OCR language settings is omitted here.

Step 708 executes by determining if an OCR accuracy after the OCR performance at step 706 meets a threshold.

If the answer of step 708 is No, then step 712 executes by adjusting the initial OCR language settings, and re-run the OCR performance on the non-searchable first PDF document, as shown at step 706. As described in FIGS. 3 and 4, the initial OCR languages settings may include three languages. For a first OCR performance, OCR device 122 may use a first language among the three languages to perform the OCR on the non-searchable first PDF document. If the accuracy is lower than the threshold, step 712 may execute by using a second language among the three languages to re-perform the OCR operation on the non-searchable first PDF document. Step 708 again executes by determining if the accuracy after the second attempt reaches the threshold.

If the answer at step 708 becomes Yes, then step 710 executes by presetting the second language settings as the OCR language settings. If the answer at step 708 is No, step 712 again executes by adjusting the language settings and re-run OCR performance at step 708 until an accuracy level above the threshold is obtained.

The preset OCR language settings are then saved in memory cache 502 (shown in FIG. 5) and are used to perform OCR on other documents, such as non-searchable second PDF document.

Now back to step 722 for the non-searchable second PDF document. If the answer of step 722 is No, then step 724 executes by performing an OCR on the entire document of the non-searchable second PDF document using the OCR language settings preset at step 710.

Next, steps 734 and 736 execute by obtaining a searchable second PDF document, and saving the searchable second PDF document in storage 110.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A computer-implemented method for improving OCR (optical character recognition) performance of documents, the method comprising:
uploading a plurality of documents;
detecting languages contained in a first document among the plurality of documents, wherein the first document is a sample document;
running a first OCR performance using a first language on the first document;
obtaining an OCR accuracy level of the first document after the first OCR performance;
setting the first language as an OCR language setting if the obtained OCR accuracy level meets a preset threshold level; and
running an OCR performance on remaining documents of the plurality of documents using the OCR language setting.

2. The computer-implemented method of claim 1, if the OCR accuracy level of the first document fails to meet the present threshold level and the first document contains a second language, the method further comprises:
running the OCR performance using the second language on the first document;
obtaining the OCR accuracy level for the second language;
if the OCR accuracy level for the second language of the fist document meets the preset threshold level,
setting the second language as the OCR language; and
running the OCR performance using the OCR language on the remaining documents.

3. The computer-implemented method of claim 2, wherein if the OCR accuracy level for the second language fails to meet the threshold level, the method further comprises running the OCR performance using a third language on the first document, wherein the first language, the second language, and the third languages are contained in the first document.

4. The computer-implemented method of claim 1, further comprising adjusting language settings based on the obtained OCR accuracy level if the obtained accuracy level does not meet the preset threshold level, and re-run the OCR performance on the first document using adjusted language settings until an obtained accuracy level meets the preset threshold level.

5. The computer-implemented method of claim 1, wherein an accuracy level obtained after running the OCR performance on the first document for a predetermined time still fails to meet the preset threshold, the computer-implemented method further comprises sending an alert message to a user for manual intervention.

6. The computer-implemented method of claim 4, wherein the adjusting the language setting includes reducing the threshold level, and re-running the OCR using the first language on the first document.

7. The computer-implemented method of claim 1, wherein the obtained OCR language setting is saved in a memory cache and is used for all remaining documents when performing an OCR on any of the remaining documents.

8. A computer-implemented method for improving OCR (optical character recognition) performance of bulk documents, the method comprising:
uploading a plurality of multi-lingual documents;
detecting languages contained in the plurality of multi-lingual documents;
detecting categories of the plurality of multi-lingual documents, wherein the categories are set based on the languages contained therein;
running a first OCR performance on a sample document using a first language;
obtaining an accuracy level of the first OCR performance;
comparing the obtained accuracy level with a preset threshold level;
setting the first language as an OCR language setting if the obtained accuracy level meets a preset threshold level in a database; and
after the OCR language setting is determined, running an OCR performance on all remaining documents within a same category of the sample document using the OCR language setting.

9. The computer-implemented method of claim 8, further comprising running a second OCR performance on the sample document using a second language if the obtained accuracy level does not meet the preset threshold.

10. The computer-implemented method of claim 9, further comprising adjusting language settings based on the obtained accuracy level before re-running the OCR performance.

11. The computer-implemented method of claim 8, wherein the OCR performance is re-run for a predetermined number of time if the obtained accuracy level after re-running the OCR performance fails to meet the threshold level.

12. The computer-implemented method of claim 11, further comprising sending an error message to a user.

13. The computer-implemented method of claim 12, further comprising manually adjusting the language settings or reducing the threshold level before re-running the OCR performance.

14. A system for managing OCR (optical character recognition) performance of documents, the system comprising:
a database storing a plurality of multi-lingual documents;
a managing device accessible to the plurality of documents stored in the database, comprising a processor, wherein the database further stores medium-readable instructions, which when executed, causes the processor to:
detect languages contained in the plurality of multi-lingual documents stored in database;
run a first OCR performance using a first language on a sample document;
obtain an accuracy level of the first OCR performance;
setting the first language as an OCR language setting if the obtained accuracy level meets a preset threshold level in a database;
run a second OCR performance using a second language on the sample document fit the obtained accuracy level does not meet the preset threshold level; and
when the OCR language setting is determined, run an OCR performance on any one of remaining document of the plurality of documents using the determined OCR language setting.

15. The computer-implemented system of claim 14, further comprising a memory cache for saving the determined OCR language setting.

16. The system of claim 14, wherein the processor is configured to repeatedly run the OCR performance on documents if an obtained accuracy level after second OCR performance fails to meet the threshold level.

17. The system of claim 16, wherein the processor is configured to adjust language settings based on the obtained accuracy level before re-running the OCR performance.

18. The system of claim 16, wherein the processor is configured to re-run the OCR performance for a predetermined number of times.

19. The system of claim 18, wherein the processor is configured to send an error message if the accuracy level of the sample document fails to meet the threshold level after OCR performance has been re-run for the predetermined number of times.

20. The system of claim 18, wherein the processor is configured to allow manually adjusting the language settings or reducing the threshold level before re-running the OCR performance.
